(19) United States
(12) Patent Application Publication
(10) Pub. No.: US 2026/0106160 A1
(43) Pub. Date: Apr. 16, 2026

(54) NEGATIVE ELECTRODE ACTIVE MATERIAL FOR LITHIUM SECONDARY BATTERY, MANUFACTURING METHOD THEREOF, NEGATIVE ELECTRODE AND LITHIUM SECONDARY BATTERY COMPRISING THE SAME

(71) Applicants: Hyundai Motor Company, Seoul (KR); Kia Corporation, Seoul (KR); Hansol Chemical Co., Ltd., Seoul (KR)

(72) Inventors: Kikang Lee, Hwaseong (KR); Seung Tae Kim, Hwaseong (KR); Sanghun Lee, Hwaseong (KR); Seung-Min Oh, Hwaseong (KR); Kimin Kwon, Hwaseong (KR); Sunghwan Kang, Iksan (KR); Changbeom Kim, Iksan (KR); Soonho Hong, Iksan (KR); Seman Kwon, Iksan (KR)

(21) Appl. No.: 19/072,190

(22) Filed: Mar. 6, 2025

(30) Foreign Application Priority Data
Oct. 10, 2024 (KR) 10-2024-0137425

(51) Int. Cl. H01M 4/62; H01M 4/02; H01M 4/36; H01M 4/38; H01M 4/587

(52) U.S. Cl. CPC H01M 4/628; H01M 4/366; H01M 4/386; H01M 4/587; H01M 2004/021; H01M 2004/027

(57) ABSTRACT

A negative electrode active material for a lithium secondary battery, a manufacturing method thereof, and a negative electrode and a lithium secondary battery comprising the same are described herein. The negative electrode active material for the lithium secondary battery comprises a core and a shell surrounding the core, wherein the core comprises a porous structure comprising flaky silicon particles and amorphous carbons, and the shell comprises flaky silicon particles, amorphous carbons, and crystalline carbons.

### CROSS-REFERENCE TO RELATED APPLICATION

This present application claims the benefit of priority to Korean Patent Application No. 10-2024-0137425, filed on Oct. 10, 2024, in the Korean Intellectual Property Office, the entire disclosure of which is incorporated herein by reference.

### BACKGROUND

### Technical Field

The present disclosure relates to a negative electrode active material for a lithium secondary battery, a manufacturing method thereof, and a negative electrode and a lithium secondary battery comprising the same.

### Background

Recently, in response to global regulations such as CO₂ and greenhouse gas emission regulations, the demand for high energy density batteries has increased. Among them, a lithium secondary battery is a secondary battery that has been most widely used as an energy storage device. Graphite is the most commonly used as an active material comprised in a negative electrode of the lithium secondary battery. However, the graphite has a low theoretical capacity per weight of 372 mAh/g, which has the limitation of energy density. Therefore, there is a disadvantage of not satisfying high energy density requirements such as a driving distance on a single charge of electric vehicles. Silicon is a negative electrode active material that has emerged as an alternative material to overcome the low capacity of graphite. The silicon has a discharge capacity per weight that is about 10 times higher than that of graphite of 3579 mAh/g, and thus is attracting attention as a next-generation negative electrode active material. However, the silicon also has a disadvantage of poor life characteristics due to particle fragmentation and electrode detachment due to a high expansion rate (up to about 300%) during a single charge. Consequent, efforts have been continuously made to mitigate the perform deterioration of properties due to volume expansion of silicon and to improve the overall cycle life.

### SUMMARY

The present disclosure was created to solve the above-described problems in the related art, and an aspect of the present disclosure is to provide a negative electrode active material for a lithium secondary battery having excellent initial efficiency and life characteristics by increasing a particle size compared to the conventional invention to reduce reaction sites on an interface between the negative electrode active material and an electrolyte, a manufacturing method thereof, and a negative electrode and a lithium secondary battery comprising the same.

In order to achieve the aspect, in one aspect, a negative electrode active material for a lithium secondary battery of the present disclosure may comprise a core and a shell at least partially surrounding the core. In one aspect, the core may comprise a porous structure comprising flaky silicon particles and amorphous carbons, and the shell may comprise flaky silicon particles, amorphous carbons, and crystalline carbons.

In one preferred aspect, the flaky silicon particles and amorphous carbons may be interlinked, for example the flaky silicon particles and amorphous carbons may be associated such as for instance physical aggregations and/or non-covalent and/or covalent bonds. Non-covalent bonds may include polar interactions such as hydrogen-bonding.

A manufacturing method of a negative electrode active material for a lithium secondary battery according to an example of the present disclosure may comprise preparing a mixture comprising silicon particles and amorphous carbon precursors, preparing a molded body by spray-drying the mixture, preparing a composite having a core-shell structure by carbonizing the molded body, and controlling the size of the composite.

The negative electrode of an example of the present disclosure may comprise a negative electrode active material positioned on the current collector, and the negative electrode active material may be a negative electrode active material for a lithium secondary battery according to various examples of the present disclosure.

A lithium secondary battery of an example of the present disclosure may comprise a positive electrode, the negative electrode according to various examples of the present disclosure, and an electrolyte.

According to the present disclosure, the negative electrode active material for the lithium secondary battery has an increased particle size compared to the conventional invention to reduce a reaction site on an interface between the negative electrode active material and an electrolyte.

Accordingly, it is possible to reduce a resistance increase speed by inhibiting the reaction and area where SEI is generated.

Therefore, the initial efficiency may be increased, and the life characteristics may be excellent.

In addition, unlike conventional inventions, the core may not contain crystalline carbons. Accordingly, an aggregation phenomenon of flaky silicon particles may be reduced, so that a core diameter may be uniform.

The negative electrode active material for the lithium secondary battery according to the present disclosure has a porous structure and pores that serve as a buffer layer, thereby buffering a volume change of silicon during charging and discharging. In addition, even after a high number of repeated cycles, the amount of cracks may be reduced, thereby improving safety.

In some embodiments, a negative electrode active material for a lithium secondary battery comprises: a core and a shell surrounding the core, wherein the core comprises a porous structure in which flaky silicon particles and amorphous carbons are interlinked, and wherein the shell comprises flaky silicon particles, amorphous carbons, and crystalline carbons.

The negative electrode active material may have a volume median diameter (Dv50) of about 9 to 11 μm.

The negative electrode active material may have a SPAN value of about 1.6 to 2.2, the SPAN value being defined as (Dv90−Dv10)/Dv50(Dv90−Dv10)/Dv50(Dv90−Dv10)/Dv50, where Dv90, Dv10, and Dv50 represent particle diameters corresponding to 90%, 10%, and 50% of a volume in a particle size distribution, respectively.

The negative electrode active material may have a distance between points where the major and minor diameters of the flaky silicon particles intersect of about 20 to 50 nm.

The negative electrode active material may have a crystal size of the flaky silicon particles of about 16 to 18 nm.

The negative electrode active material may have a shell thickness of about 20 to 300 nm.

The negative electrode active material may not comprise or may be substantially free of crystalline carbons in the core.

In some embodiments, a method of manufacturing a negative electrode active material for a lithium secondary battery comprises: preparing a mixture comprising silicon particles and amorphous carbon precursors, preparing a molded body by spray-drying the mixture, preparing a composite having a core-shell structure by carbonizing the molded body, and controlling the size of the composite.

The method may include adding crystalline carbons and amorphous carbon precursors and performing heat treatment when preparing the composite having the core-shell structure.

The method may include adding about 47 to 57 wt % of crystalline carbons and about 65 to 75 wt % of amorphous carbon precursors, based on the total weight of the silicon particles.

The method may include performing the heat treatment at about 900 to 1100° C.

In the method, the crystalline carbon may be flaky graphite having a volume median diameter Dv50 of about 10 to 100 μm.

In the method, the amorphous carbon precursor may be any one selected from the group consisting of a phenol resin, a furan resin, a coal pitch, a petroleum pitch, and combinations thereof.

In the method, the amorphous carbon precursor may be a petroleum pitch having a volume median diameter Dv50 of about 1 to 10 μm.

The method may include controlling the volume median diameter Dv50 of the composite to about 9 to 11 μm.

The method may include controlling a SPAN value of the composite to about 1.6 to 2.2, the SPAN value being defined as (Dv90−Dv10)/Dv50(Dv90−Dv10)/Dv50(Dv90−Dv10)/Dv50.

In the composite having the core-shell structure produced by the method, the core may comprise a porous structure in which flaky silicon particles and amorphous carbons are interlinked, and the shell may comprise flaky silicon particles, amorphous carbons, and crystalline carbons.

The method may result in the core not comprising or being substantially free of crystalline carbons.

The method may produce a shell having a thickness of about 20 to 300 nm.

In some embodiments, a negative electrode comprising the negative electrode active material is provided.

As referred to herein, in at least certain aspects, a flaky silicon particles can be considered as more substantially two-dimensional structure, where dimensions X and Y are substantially larger (e.g. at least 10, 20, 30, 40, 50, 100, 200 300, 400, or 500% larger) than dimension Z. Flaky silicon particles may be considered as flake-like silicon particles and in aspects may be considered as flakes.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a schematic diagram of a negative electrode active material for a lithium secondary battery of the present disclosure;

FIG. 2 is a schematic diagram schematically illustrating a porous structure comprised in a core according to an example of the present disclosure;

FIG. 3 is a process flowchart of a manufacturing method of a negative electrode active material for a lithium secondary battery of the present disclosure;

FIG. 4 is a process diagram schematically illustrating a manufacturing method of a negative electrode active material for a lithium secondary battery according to various examples of the present disclosure;

FIG. 5 is an XRD result illustrating the sizes of flaky silicon particles of Example 3;

FIG. 6 is an SEM image showing a core part of Example 3;

FIG. 7 is a graph showing particle size distributions of Examples and Comparative Examples;

FIG. 8 is SEM images of Example 3 and Comparative Example 3, in which FIG. 8A is an SEM image of Comparative Example 3, and FIG. 8B is an SEM image of Example 3;

FIG. 9 is a graph showing the initial capacity and initial efficiency of Example 3;

FIG. 10 is a graph showing the capacity retention rates of Example and Comparative Example for 300 cycles;

FIG. 11 is an image of a negative electrode after 300 cycles, in which FIG. 11 (a) is an image of Comparative Example 3, and FIG. 11 (b) is an image of Example 3; and

FIG. 12 is cross-sectional SEM images of a negative electrode before and after 300 cycles, in which FIG. 12 (a) is an initial SEM image of Comparative Example 3, FIG. 12 (b) is an initial SEM image of Example 3, FIG. 12 (c) is an SEM image of Comparative Example 3 after 300 cycles, and FIG. 12 (d) is an SEM image of Example 3 after 300 cycles.

### DETAILED DESCRIPTION

All terms used herein comprising technical or scientific terms have the same meanings as generally understood by those skilled in the art unless otherwise defined. Terms defined in generally used dictionary shall be construed to have meanings matching those in the context of a related art and shall not be construed in ideal or excessively formal meanings unless otherwise clearly defined in the present disclosure.

As used in the present disclosure, the terms comprising as first, second, and the like may be used for describing various components, but the components are not limited by the terms. These terms are only used to distinguish one component from another component. For example, without departing from the scope of the present disclosure, a first component may be named as a second component, and similarly, a second component may be named as a first component.

The terms used in the present disclosure are used for the purpose of describing particular examples only and are not intended to limit the present disclosure. A singular expression comprises a plural expression unless otherwise defined differently in a context. In the present disclosure, it should be understood that term “comprising” or “having” indicates that a feature, a number, a step, an operation, a component, a part or a combination thereof described in the specification is present but does not exclude a possibility of presence or addition of one or more other features, numbers, steps, operations, components, parts or combinations thereof, in advance.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMS, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, examples of the present disclosure will be described in detail with reference to the accompanying drawings.

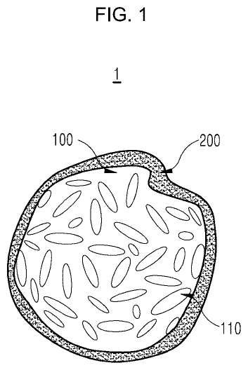

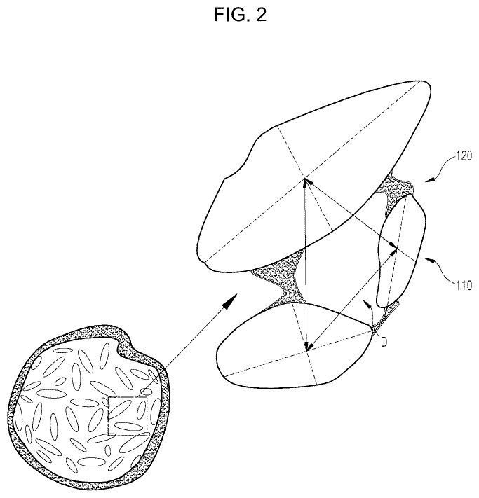

First, a negative electrode active material 1 for a lithium secondary battery of the present disclosure will be described with reference to FIGS. 1 and 2.

FIG. 1 is a schematic diagram of the negative electrode active material 1 for the lithium secondary battery of the present disclosure.

FIG. 2 is a schematic diagram schematically illustrating the negative electrode active material 1 for the lithium secondary battery according to an example of the present disclosure and a porous structure comprised in a core 100.

Referring to FIG. 1, the negative electrode active material 1 for the lithium secondary battery of the present disclosure may comprise the core 100 and a shell 200 surrounding the core 100. The core 100 may comprise flaky silicon particles 110 and amorphous carbons 120.

At this time, the flaky silicon particles 110 and the amorphous carbons 120 may be interlinked. In some embodiments of the present disclosure, the interlinking means a shape in which amorphous carbons 120 are attached or connected between a plurality of flaky silicon particles 110 without a specific rule, as shown in FIG. 2.

In the present disclosure, the flaky silicon particles 110 and the amorphous carbons 120 may be interlinked to form a porous structure. In the present disclosure, the porous structure may comprise spaces or pores formed by interlinking the flaky silicon particles 110 and the amorphous carbons 120, as shown in FIG. 2. Meanwhile, the flaky silicon particles 110, the amorphous carbons 120 and the spaces therebetween in FIGS. 1 and 2 are only examples and are not limited to their shapes.

In the negative electrode active material 1 for the lithium secondary battery according to the present disclosure, the core 100 comprises a porous structure in which the flaky silicon particles 110 and the amorphous carbons 120 are interlinked to serve as a buffer layer that buffers the volume expansion of silicon that occurs during charging and discharging of the lithium secondary battery. Therefore, even after continuous charging and discharging, the amount of occurring cracks may be reduced, thereby improving safety.

In various examples of the present disclosure, a distance D between points where the major and minor diameters of the flaky silicon particles 110 intersect may be 20 to 50 nm.

In various examples of the present disclosure, the crystal size of the flaky silicon particle 110 may be 16 to 18 nm. At this time, the crystal size of the particle may be obtained by Equation of Kλ/FWHM×cos θ according to the Debye-Scherrer equation. Here, K is a shape factor and has a value of about 0.9, λ represents an X-ray wavelength, FWHM represents a full width at half maximum, and θ represents an X-ray incidence angle.

Meanwhile, the negative electrode active material 1 for the lithium secondary battery according to the present disclosure may not comprise crystalline carbons in the core 100, unlike a conventional invention. In some embodiments, the negative electrode active material 1 for the lithium secondary battery according to the present disclosure may be substantially free of crystalline carbons in the core 100. As used herein, “substantially free of” means that the amount of crystalline carbon is present in an amount that does not materially affect the characteristics or performance of the material. For example, “substantially free of” may refer to a content of crystalline carbon that is less than about 5 wt. %, or less than about 1 wt. %, or even 0 wt. %. Accordingly, an aggregation phenomenon of the flaky silicon particles 110 may be reduced, so that the diameter of the core 100 may be uniform. In addition, since relatively coarse crystalline carbons are not comprised, the diameter and shape of the core 100 may be uniform.

The shell 200 comprised in the negative electrode active material 1 for the lithium secondary battery according to the present disclosure may comprise the flaky silicon particles 110, the amorphous carbons 120, and crystalline carbons. At this time, the crystalline carbon may be flaky graphite. When the flaky graphite is comprised in the shell 200, conductivity may be improved through contact with the flaky silicon particles 110. In one example, the flaky graphite may have a carbon content of more than 99.9%, an oxygen content of less than 0.5%, and a moisture content of less than 1%.

In one example of the present disclosure, the thickness of the shell 200 may be 20 to 300 nm.

A volume median diameter Dᵥ50 of the negative electrode active material 1 for the lithium secondary battery according to the present disclosure may be 9 to 11 μm. The negative electrode active material 1 for the lithium secondary battery according to the present disclosure has an increased particle diameter compared to the conventional invention to reduce a reaction site on an interface between the negative electrode active material 1 and the electrolyte. Accordingly, it is possible to reduce a resistance increase speed by inhibiting the reaction and area where SEI is generated. Therefore, the initial efficiency may be increased and the life characteristics may be excellent.

A SPAN value of the negative electrode active material 1 for the lithium secondary battery according to the present disclosure may be 1.6 to 2.2. The SPAN value is used as a particle size distribution regulation index and is defined as (Dᵥ90−Dᵥ10)/Dᵥ50. Here, Dᵥ90, Dᵥ10, and Dᵥ50 represent particle diameters corresponding to 90%, 10%, and 50% of the volume in a size distribution, respectively. In other words, the SPAN value represents the degree to which the diameter of the large particle and the diameter of the small particle deviate from a volume median diameter Dᵥ50, and means that the smaller value, more uniform particle size. The negative electrode active material 1 for the lithium secondary battery according to the present disclosure may have the SPAN value of 1.6 to 2.2, so that the particle size is uniform and the capacity retention rate may be excellent.

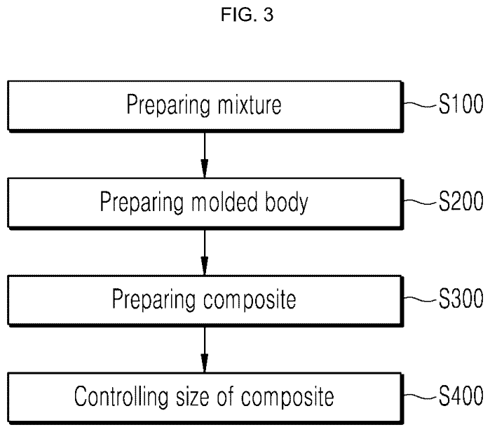

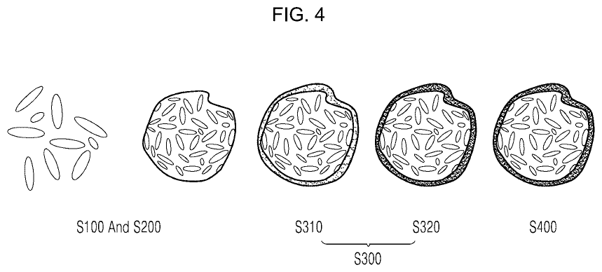

Hereinafter, a manufacturing method of a negative electrode active material for a lithium secondary battery according to the various examples of the present disclosure will be described with reference to FIGS. 3 and 4. FIG. 3 is a process flowchart of a manufacturing method of a negative electrode active material for a lithium secondary battery of the present disclosure. FIG. 4 is a process diagram schematically illustrating a manufacturing method of a negative electrode active material for a lithium secondary battery according to various examples of the present disclosure.

Referring to FIG. 3, the manufacturing method of the negative electrode active material for the lithium secondary battery according to the present disclosure may comprise preparing a mixture (S100), preparing a molded body (S200), preparing a composite (S300), and controlling the size of the composite (S400).

The preparing of the mixture (S100) of the present disclosure may be, specifically, preparing a mixture comprising silicon particles and amorphous carbon precursors. In the preparing of the mixture (S100), the silicon particles may be pulverized through a milling process. The milling process may be wet milling. For example, the wet milling may be a bead mill, but is not limited to any one type and may be applied if the process is a conventional wet milling process.

At this time, the silicon particles may be flaky silicon particles. In one example, the pulverized flaky silicon particles may be in the form of slurry.

The amorphous carbon precursor may be any one selected from the group consisting of a phenol resin, a furan resin, a coal pitch, a petroleum pitch, and combinations thereof. In one example, the amorphous carbon precursor may be a petroleum pitch having a volume median diameter Dᵥ50 of 1 to 10 μm. At this time, the softening point of the petroleum pitch may be 200 to 250° C.

The amorphous carbon precursor may form amorphous carbon by removing an inner organic material in a heat treatment step (S320) to be described below.

The preparing of the molded body (S200) of the present disclosure may be specifically preparing a molded body by spray-drying the mixture. The molded body may form a porous structure in which the flaky silicon particles and the amorphous carbons are interlinked as described above. In one example, the molded body may be in a powder form.

The preparing of the composite (S300) of the present disclosure may be specifically carbonizing the molded body to prepare a composite having a core-shell structure.

Referring to FIG. 4, the preparing of the composite (S300) may comprise adding crystalline carbons and amorphous carbon precursors (S310) and performing a heat treatment (S320).

The adding of the crystalline carbons and the amorphous carbon precursors (S310) may be performed in a form coated on the surface of the molded body. The molded body may form a core structure, and the crystalline carbons and the amorphous carbon precursors may be coated on the surface of the molded body to form a shell structure. In one example, the flaky silicon particles may be added together with the crystalline carbons and the amorphous carbon precursors to be coated on the surface of the molded body.

When the crystalline carbons and the amorphous carbon precursors are coated on the surface of the molded body, it is possible to prevent direct contact between the core and the electrolyte, suppress volume expansion, and improve conductivity.

The crystalline carbon may be flaky graphite having a volume median diameter Dv50 of 10 to 100 μm. In one example, the flaky graphite may have a carbon content of more than 99.9%, an oxygen content of less than 0.5%, and a moisture content of less than 1%.

The amorphous carbon precursor may be any one selected from the group consisting of a phenol resin, a furan resin, a coal pitch, a petroleum pitch, and combinations thereof. In one example, the amorphous carbon precursor may be a petroleum pitch having a volume median diameter Dᵥ50 of 1 to 10 μm. At this time, the softening point of the petroleum pitch may be 200 to 250° C.

In the adding of the crystalline carbons and the amorphous carbon precursors (S310), 47 to 57 wt % of the crystalline carbons may be added and 65 to 75 wt % of the amorphous carbon precursors may be added with respect to the total weight of the silicon particles in the molded body.

Meanwhile, the heat treatment step (S320) may be performed at 900 to 1100° C. Through the heat treatment step (S320), the molded body may be finally carbonized. In addition, the organic material in the amorphous carbon precursor may be removed to form amorphous carbon. That is, the amorphous carbon precursors comprised in the core and the shell described above may form amorphous carbons by removing the organic materials therein.

Meanwhile, the core of the prepared core-shell composite may comprise a porous structure in which the flaky silicon particles and the amorphous carbons are interlinked as described above. The shell may comprise flaky silicon particles, amorphous carbons and crystalline carbons and may be in the form of surrounding the core.

The controlling of the size of the composite (S400) of the present disclosure may be disintegrating and classifying the composite. The disintegrating refers to dispersing a material that has been aggregated with a relatively weak force, such as particle aggregates or granules, during a broad sense of pulverizing. In the controlling of the size of the composite (S400), the aggregation of the prepared composite may be resolved through disintegration.

In addition, in the composite prepared through classification, fine particles exceeding a specific size may be removed, or coarse particles exceeding a specific size may be removed.

The controlling of the size of the composite (S400) of the present disclosure may allow the volume median diameter Dᵥ50 of the composite having the core-shell structure to be 9 to 11 μm. The composite having the core-shell structure with such a controlled size may have an increased particle size compared to the conventional invention, thereby reducing a reaction site on an interface between the negative electrode active material and the electrolyte. Accordingly, it is possible to reduce a resistance increase speed by inhibiting the reaction and area where SEI is generated. Therefore, the initial efficiency may be increased and the life characteristics may be excellent.

The controlling of the size of the composite (S400) of the present disclosure may allow the SPAN value of the composite to be 1.6 to 2.2.

The negative electrode of the present disclosure comprises a current collector and a negative electrode active material positioned on the current collector, and the negative electrode active material may be a negative electrode active material for a lithium secondary battery according to various examples of the present disclosure. The negative electrode current collector is not particularly limited as long as the negative electrode current collector has conductivity without causing a chemical change in the lithium secondary battery. For example, the negative electrode current collector may be used with copper, stainless steel, aluminum, nickel, titanium, plastic carbon, copper or stainless steel surface-treated with carbon, nickel, titanium, silver, etc., an aluminum-cadmium alloy, and the like.

The lithium secondary battery of the present disclosure may comprise a positive electrode, the negative electrode according to various examples of the present disclosure, and an electrolyte. The positive electrode may comprise a positive electrode active material and a current collector. As the positive electrode active material, one or at least two types of lithium-containing transition metal oxides generally used in the lithium secondary battery may be mixed and used, but are not necessarily limited thereto. As the lithium-containing transition metal oxide, for example, a composite oxide of lithium and cobalt, nickel, manganese, etc. may be used. The positive electrode current collector may be used without limitation as long as the positive electrode current collector has good conductivity, may easily adhere to slurry of the positive electrode active material, and has no reactivity in a voltage range of the battery, and examples thereof comprise aluminum Al, nickel Ni, etc.

The electrolyte may comprise a lithium salt. The lithium salt may act as a passage through which lithium ions may move, and may be used with LiPF₆, LiBF₄, LiBOB, LiTFSI, and the like, but is not necessarily limited thereto. In addition, the electrolyte may comprise a solvent and an additive, but is not limited to any one type, and any solvent and additive commonly used may be used.

Hereinafter, the present disclosure will be described in more detail with reference to Examples. However, the following Examples and Experimental Examples are only intended to describe the present disclosure in more detail, and the scope of the present disclosure is not limited by the following Examples and Experimental Examples.

### EXAMPLES AND COMPARATIVE EXAMPLES

In order to manufacture a negative electrode active material for a lithium secondary battery, a slurry-type mixture containing flaky silicon particles and petroleum pitches was prepared. The mixture was spray-dried to prepare a powder-type molded body. Thereafter, flaky graphite, petroleum pitches, and flaky silicon particles were coated on the molded body, and a negative electrode active material having a core-shell structure was manufactured through heat treatment at about 1000° C. Thereafter, the size of the negative electrode active material was controlled through disintegration and classification.

Meanwhile, in the manufacturing process, the conditions of slurry solid content, nozzle injection angle, temperature in a chamber, injection speed, and air flow rate were set differently during spray-drying. In addition, the conditions of powder feeding speed, pulverizing pressure, and air flow rate were set differently during disintegration. The negative electrode active materials of Examples and Comparative Examples were finally manufactured by varying the conditions above, and physical properties thereof were shown in Table 1 below.

Meanwhile, in Table 1, D means a distance between points where the major and minor diameters of the flaky silicon particles intersect.

TABLE 1

| | | Physical property | | | | | |
|---|---|---|---|---|---|---|---|
| | | Particle size (μm) | | | | | |
| | | Dᵥ10 | Dᵥ50 | Dᵥ90 | Dᵥ90 | SPAN | D (nm) |
| Example | 1 | 3.5 | 10.5 | 32.3 | 163.0 | 2.74 | 21 |
| | 2 | 3.7 | 10.6 | 25.9 | 58.8 | 2.09 | 22 |
| | 3 | 4.3 | 10.4 | 22.1 | 40.1 | 1.7 | 23 |
| | 4 | 5.8 | 10.1 | 16.8 | 24.9 | 1.09 | 21 |
| | 5 | 5.0 | 14.1 | 30.3 | 75.6 | 1.79 | 21 |
| | 6 | 5.6 | 14.0 | 26.4 | 45.5 | 1.49 | 21 |
| | 7 | 8.3 | 14.8 | 27.5 | 58.7 | 1.30 | 22 |
| Comparative | 1 | 3.2 | 7.5 | 17.5 | 45.4 | 1.92 | 23 |
| Example | 2 | 3.5 | 7.5 | 16.3 | 40.1 | 1.71 | 22 |
| | 3 | 3.5 | 7.6 | 14.7 | 27.1 | 1.48 | 21 |

### Experimental Example 1

### Morphology Observation

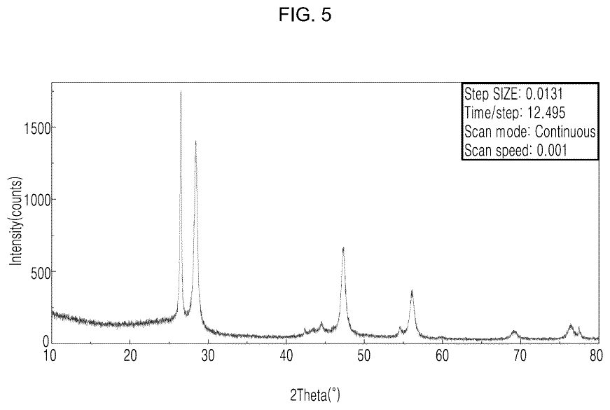

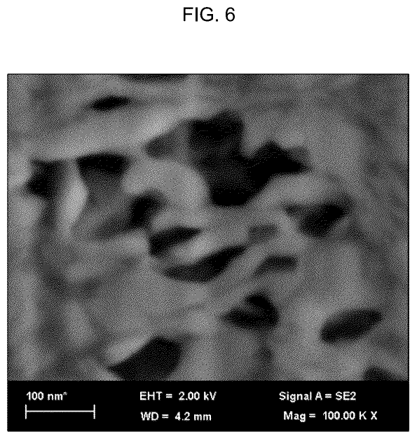

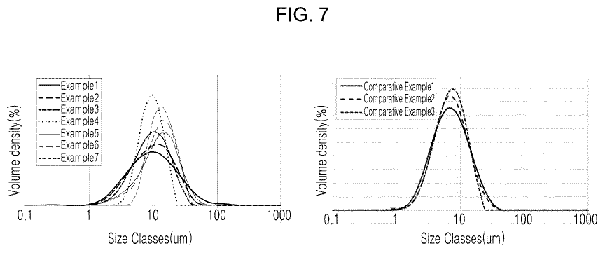

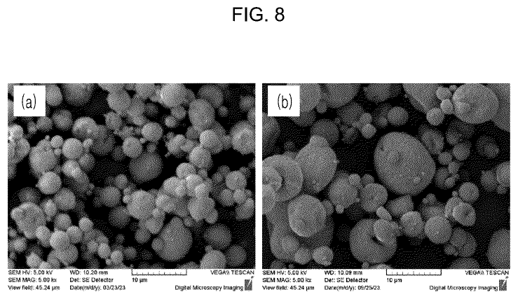

In Experimental Example, the morphologies of Examples and Comparative Examples were analyzed. FIG. 5 is an XRD result showing the sizes of the flaky silicon particles of Example 3. FIG. 6 is an SEM image showing a core part of Example 3. Referring to FIGS. 5 and 6, pores may be observed, which may confirm a porous structure in which the flaky silicon particles and amorphous carbons are interlinked. FIG. 7 is a graph showing particle size distributions of Examples and Comparative Examples. Referring to FIG. 7, it may be seen that the particle size distribution of Examples has been composed in the range of about 2 μm larger than that of Comparative Examples. FIG. 8 is SEM images of Example 3 and Comparative Example 3. FIG. 8A is an SEM image of Comparative Example 3, and FIG. 8B is an SEM image of Example 3. Referring to FIG. 8, it may be observed that the particle size of Example is larger than that of the Comparative Example. Through this, the same conclusion may be reached as the result of the particle size distribution graph of FIG. 7.

### Experimental Example 2

### Analysis of Electrochemical Characteristics

In Experimental Example, cells comprising the negative electrode active materials of Examples and Comparative Examples were manufactured and the electrochemical characteristics were analyzed. The initial specific discharge capacity, initial efficiency, and capacity retention rate for 300 cycles were measured. The results thereof were shown in Table 2 below.

TABLE 2

| | | Electrochemical characteristic | | |
|---|---|---|---|---|
| | | Initial specific | | Capacity |
| | | discharge capacity | Initial | retention rate |
| | | (mAh/g) | efficiency (%) | (300 cycle, %) |
| Example | 1 | 1,405 | 88.8 | 84.8 |
| | 2 | 1,407 | 89.2 | 93.0 |
| | 3 | 1,391 | 88.3 | 92.1 |
| | 4 | 1,374 | 89.0 | 83.1 |
| | 5 | 1,421 | 89.1 | 85.0 |
| | 6 | 1,400 | 88.8 | 91.9 |
| | 7 | 1,399 | 88.7 | 88.4 |
| Comparative | 1 | 1,412 | 88.4 | 83.7 |
| Example | 2 | 1,427 | 88.8 | 86.0 |
| | 3 | 1,404 | 89.3 | 82.2 |

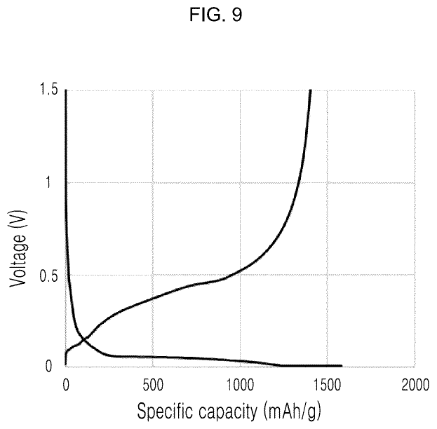

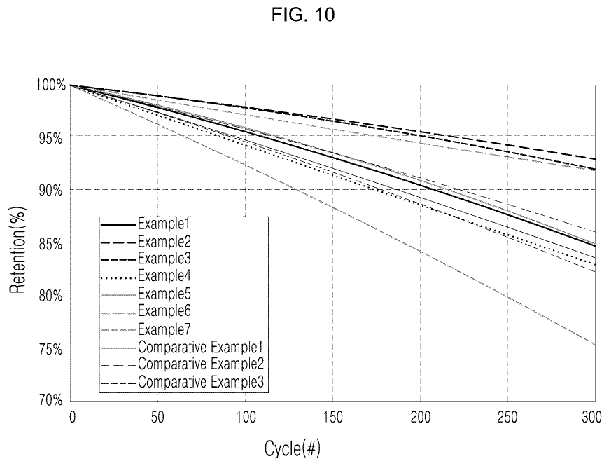

FIG. 9 is a graph showing the initial capacity and initial efficiency of Example 3. FIG. 10 is a graph showing the capacity retention rate of Example and Comparative Example for 300 cycles. Referring to Table 2 and FIGS. 9 and 10, it may be seen that in Example and Comparative Example, the initial specific discharge capacity was approximately 1400 mAh/g and the initial efficiency was 88 to 90%.

In order to further investigate the cycle characteristics, pouch-type cells (full cells) comprising the negative electrode active materials of Example 3 and Comparative Example 3 were manufactured, and the states of the negative electrodes after 300 cycles were compared and analyzed.

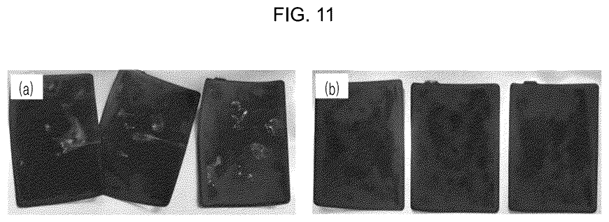

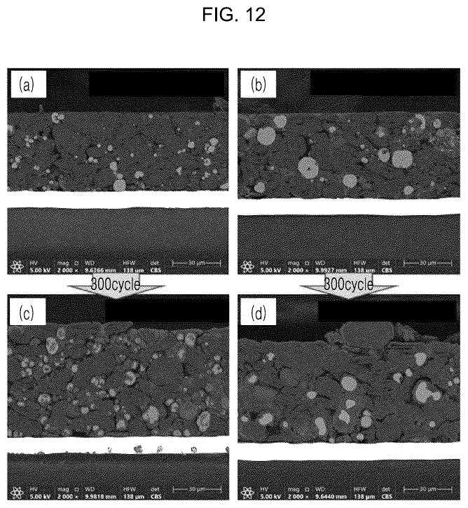

FIG. 11 is an image of a negative electrode after 300 cycles. FIG. 11 (a) is an image of Comparative Example 3, and FIG. 11 (b) is an image of Example 3. FIG. 12 is cross-sectional SEM images of a negative electrode before and after 300 cycles. FIG. 12 (a) is an initial SEM image of Comparative Example 3, FIG. 12 (b) is an initial SEM image of Example 3, FIG. 12 (c) is an SEM image of Comparative Example 3 after 300 cycles, and FIG. 12 (d) is an SEM image of Example 3 after 300 cycles. Referring to Table 2 and FIGS. 10 to 12, it may be seen that in Comparative Examples, more cracks occurred than in Examples, and that deterioration that may be observed with the naked eye occurred. In fact, referring to Table 2, it may be seen that in Comparative Examples, the capacity retention rate was 82 to 86%, while in Examples, the capacity retention rate was 83 to 93%.

This may be presumed because in the case of Examples, the particle size of the negative electrode active material is relatively coarse to efficiently control the volume expansion of the negative electrode, thereby improving the life characteristics.

Hereinabove, the present disclosure has been described with reference to preferred examples thereof. It will be understood to those skilled in the art that the present disclosure may be implemented as modified forms without departing from an essential characteristic of the present disclosure. Therefore, the disclosed examples should be considered in an illustrative viewpoint rather than a restrictive viewpoint. The scope of the present disclosure is illustrated by the appended claims rather than by the foregoing description, and all differences within the scope of equivalents thereof should be construed as being comprised in the present disclosure.

### EXPLANATION OF REFERENCE NUMERALS AND SYMBOLS

1: Negative electrode active material
100: Core
110: Flaky silicon particle
120: Amorphous carbon
200: Shell
D: Distance between points where major and minor diameters of flaky silicon particle intersect
S100: Preparing mixture
S200: Preparing molded body
S300: Preparing composite
S310: Adding crystalline carbons and amorphous carbon precursors
S320: Heat-treatment
S400: Controlling size of composite

What is claimed is:

1. A negative electrode active material for a lithium secondary battery, the negative electrode active material comprising:
a core and a shell surrounding at least a portion of the core,
wherein the core comprises a porous structure comprising flaky silicon particles and amorphous carbons, and
wherein the shell comprises flaky silicon particles, amorphous carbons, and crystalline carbons.

2. The negative electrode active material of claim 1, wherein at least portions of the flaky silicon particles and amorphous carbons are interlinked.

3. The negative electrode active material of claim 1, wherein a volume median diameter (Dᵥ50) of the negative electrode active material is about 9 to 11 μm.

4. The negative electrode active material of claim 1, wherein a SPAN value of the negative electrode active material is about 1.6 to 2.2, the SPAN value being defined as (Dv90−Dv10)/Dv50), where Dv90, Dv10, and Dv50 represent particle diameters corresponding to 90%, 10%, and 50% of the volume in the particle size distribution of the negative electrode active material, respectively.

5. The negative electrode active material of claim 1, wherein a distance between points where the major and minor diameters of the flaky silicon particles intersect is about 20 to 50 nm.

6. The negative electrode active material of claim 1, wherein a crystal size of the flaky silicon particle is about 16 to 18 nm.

7. The negative electrode active material of claim 1, wherein a thickness of the shell is about 20 to 300 nm.

8. A manufacturing method of a negative electrode active material for a lithium secondary battery, the manufacturing method comprising:
preparing a mixture comprising silicon particles and amorphous carbon precursors;
preparing a molded body comprising the mixture;
preparing a composite having a core-shell structure by carbonizing the molded body; and
controlling the size of the composite.

9. The manufacturing method of claim 8, wherein the preparing of the composite having the core-shell structure by carbonizing the molded body comprises:
adding crystalline carbons and amorphous carbon precursors; and
performing heat treatment.

10. The manufacturing method of claim 9, wherein in the adding of the crystalline carbons and the amorphous carbon precursors,
with respect to the total weight of the silicon particles,
about 47 to 57 wt % of the crystalline carbons; and
about 65 to 75 wt % of the amorphous carbon precursors are added.

11. The manufacturing method of claim 8, wherein the crystalline carbon is flaky graphite having a volume median diameter Dᵥ50 of about 10 to 100 μm.

12. The manufacturing method of claim 8, wherein the amorphous carbon precursor is any one selected from the group consisting of a phenol resin, a furan resin, a coal pitch, a petroleum pitch, and combinations thereof.

13. The manufacturing method of claim 8, wherein the amorphous carbon precursor is a petroleum pitch having a volume median diameter Dᵥ50 of about 1 to 10 μm.

14. The manufacturing method of claim 8, wherein in the controlling of the size of the composite, a volume median diameter Dᵥ50 of the composite is about 9 to 11 μm.

15. The manufacturing method of claim 8, wherein in the controlling of the size of the composite, an SPAN value of the composite is about 1.6 to 2.2, the SPAN value being defined as (Dv90−Dv10)/Dv50), where Dv90, Dv10, and Dv50 represent particle diameters corresponding to 90%, 10%, and 50% of the volume in the particle size distribution of the negative electrode active material, respectively.

16. The manufacturing method of claim 8, wherein in the composite having the core-shell structure,
the core comprises a porous structure in which flaky silicon particles and amorphous carbons are interlinked, and
the shell comprises flaky silicon particles, amorphous carbons, and crystalline carbons.

17. The manufacturing method of claim 7, wherein the core does not comprise or is substantially free of crystalline carbons.

18. The manufacturing method of claim 7, wherein a thickness of the shell is about 20 to 300 nm.

19. A negative electrode comprising a negative electrode active material of claim 1.

20. The negative electrode active material of claim 1, wherein the core does not comprise or is substantially free of crystalline carbons.
